(19) United States
(12) Patent Application Publication
(10) Pub. No.: US 2018/0048934 A1
(43) Pub. Date: Feb. 15, 2018

(54) System For The Transmission Of Data For Television Programmes In A Defined Area

(71) Applicant: Global Invacom Ltd., Stevenage, Hertfordshire (GB)

(72) Inventors: Gary Stafford, Stevenage, Hertfordshire (GB); Steven Fisher, Stevenage, Hertfordshire (GB)

(21) Appl. No.: 15/551,560

(22) PCT Filed: Feb. 16, 2016
(86) PCT No.: PCT/GB2016/050371

§ 371 Date: Aug. 16, 2017

(30) Foreign Application Priority Data
Feb. 16, 2015 (GB) 1502546.3
Feb. 19, 2015 (GB) 1502757.6

(51) Int. Cl. H04N 21/4363; H04N 21/4227

(52) U.S. Cl. CPC H04N 21/43637; H04N 21/4227; H04N 7/08

(57) ABSTRACT

This invention relates to a system which allows the user selection of programs to be viewed and or listened to from a group of channels or programs which is a subset of the data for programs or channels which are received by a server in a conventional manner. The subset or group is selected in accordance with predefined criteria and the data for the group is then wirelessly transmitted to a defined area, within which users, via a user interface provided on their device, can choose to select a program from the group. In one embodiment the data for the group of programs or channels is adapted prior to transmission to allow the wireless transmission to be more reliable and in one embodiment the data for the group is transmitted as a multicast.

The invention to which this application relates is a system which allows the communication of data relating, typically, although not necessarily exclusively, to television or radio programmes and allows the communication of said data from one or more sources to one or more further locations. In one embodiment, the system also allows the operation of the source from said one or more further locations by allowing the two way transmission of data.

In the provision of broadcast data to a premises, the user typically has the option of paying a subscription for, or buying, a receiving apparatus, typically referred to as a set top box or broadcast data receiver, and which acts as a source at the physical location of the apparatus for radio and television channels and/or other services via a display screen and/or speakers of the device to which the same is connected, or provided integrally with. This form of apparatus is well known and allows for the processing and/or storage of data and allows the generation of a television or radio channel selected by the user from a range of available television or radio channels which can be generated.

While this form of system operates in a desired manner for data which is broadcast via satellite, cable and/or terrestrial broadcast systems, and provides the radio and television channels in the premises in the room at the location at which the source is located, problems arise when it is desired that television and/or radio channels from the said service are desired to be displayed or listened to via a display screen and/or speakers at different locations in the building. Problems can also arise in public access areas where there may be a demand for a range of devices to be provided with video and/or audio data to be provided and for the same to be used to display different video and/or audio to the devices respective users.

In the distribution of data to allow the generation of video and/or audio therefrom, effectively to a plurality of relatively dense, high user receiver locations, such as in public areas e.g cafes, public transport terminus and the like the use of on demand or “player” services is common such as the BBC i-player service. This allows users to request a particular program from a list of available historical programs and the data for the selected programme is transmitted to the users device at the location via a broadband internet connection to that location and the devices is used to generate the video and audio for the selected programme.

When the data is to be provided live the data for the user selected programme is selected from the data which is being broadcast at that time at the receiver location for the programmes which are scheduled to be shown at that time, and the selected programme can be viewed. Alternatively, if the user selects to use one of the on-demand services, such as the i-player or Netflix services, the user can select to view a programme from a catalogue of current or previously available, programmes. The use of the broadband network internet service such as via a fixed cable or wireless telephone network allows the data to be provided to a small number of devices but when the demand from the number of devices becomes greater, such as in a café or other public are such as a transport hub, it is found that the broadband network used to deliver the data cannot cope with the demand and the service fails to all of the users or, at least, is adversely affected. Thus, the relatively large amounts of data which are required to be simultaneously transmitted via the broadband network to the receiving location in order to allow the selected programme to be generated puts considerable strain on the broadband network and the capacity of the same to provide data to one receiver device location or a number of receiver devices locations.

A further problem is the capability of the wireless distribution system at the location at which the devices are in use, such as for example the wireless system which is used at a café and which can be accessed by members of the public when in the café. Frequently, the wireless system is not capable of being able to distribute the data which is required to be sent to each of the devices in order for that device to be able to provide the selected programme to the user via their respective device. This therefore means that at resent there are two distinct bottlenecks to the provision of the required service to device users, the first potential bottleneck being the broadband provision of the data to the premises and the second potential bottleneck being the wireless distribution of the data at the location at which the devices are to be used. This means that the successful provision of the data for the whole programme for the users may not be achieved due to problems with the broadband connection during the transmission of the data, the transmission of the data may be slow due to the capacity problems and/or the provision of other services via the broadband connection can be compromised; all of which can lead to frustration for the user and system problems to the internet broadband provider.

A further problem can be experienced where a number of receiver locations are required in a same or close locations and in which the common solution is for the user to either purchase another receiver apparatus which operates independently of the first set and is located at the said further location, or alternatively, a coaxial cable connection can be provided between the set of apparatus at the first location and the display screen and/or speakers at the further location. This allows data from the first set of apparatus to be transferred and generated at the second location. The problem with the former solution is that the same is expensive in that the further apparatus is required to be purchased and/or a further subscription is required to be purchased. Furthermore, additional cabling may also be required to be installed. With the latter solution, additional cabling is required to be installed which can be disruptive and/or expensive and in certain instances may not be possible to achieve. Furthermore, when multiple display screens and/or speakers are provided at different locations, there is no, or only a very limited, ability for different video and/or audio to be provided via the different screens and/or speakers and so, most commonly, the same video and/or audio is provided at each of the locations.

An aim of the present invention is to provide apparatus and a method which allows the efficient and effective provision of data to one or more receiver locations in a manner which allows the data to be received in a timely manner upon the selection of a particular programme or broadband service having been made by the user. A further aim is to allow the data transmission to be made in a manner which prevents or reduces the risk of overload of the broadband network system used to transmit the data.

A yet further aim of the present invention is to allow the provision of data from data receiving apparatus at a first or plurality of locations to display apparatus at one or more further locations, typically within or adjacent to the same premises, in order to allow data from the first apparatus location to be available at the apparatus at the said one or more further locations. A further aim is to provide a system which allows the source of data for each of the display apparatus to be selected from a plurality of data receiving apparatus and, if required, subsequently altered to meet user requirement.

In a first aspect of the invention there is provided a system for the transmission of data to a plurality of user devices from one or more sources, said user devices located within a defined area, said user devices provided with the capability of receiving data transmitted wirelessly within said defined area and processing the same in order to allow video and/or audio to be generated from the received data by the user device, said user device including means to allow user interaction via the device in order to select, from a group of available programmes or programme channels, a programme to be viewed and/or listened to via the device, and data for the selected programme is obtained from the wirelessly transmitted data so as to be available to that user device, and wherein the said group of available programmes or channels is selected with reference to predefined criteria by a server which receives data from the one or more sources and is provided in connection with wireless transmission apparatus located so as to transmit data wirelessly to the defined area and thereby make available to the said user devices when located in the said defined area the data for the said group of available programmes or channels.

In one embodiment the said group of available programmes or channels is a subset of the programmes for which data is broadcast to the server from one or more said sources in the form of any or any combination of satellite, cable, DAB, DVBT transmission sources.

In one embodiment the said predefined criteria are determined by a service provider for the defined area and/or the owner or operator of a premises within which the defined are is located.

In one embodiment the data for the said group of programmes or channels is adapted following receipt by the server and prior to wireless transmission in order to render the data in a preferred format for wireless transmission.

In one embodiment the data received at the server is adapted into an Internet Protocol (IP) format by the server and the selection is made of the data for the said group of programmes or channels.

Typically the adaptation includes Forward Error Correction (FEC) and/or transcoding of the data for the group of programmes or channels.

Typically the adaptation includes a reduction of the bit rate at which the data is to be wirelessly transmitted so that the same is sufficiently low so as to ensure reliable transmission of the data to the user devices within the said defined area.

In one embodiment the data for the programmes in the said group of programmes or channels is multicast wirelessly from the server and wireless transmission apparatus within the said defined area so that the data for all of the group of programmes or channels is available to be selected and received by all of the user devices located within the defined area.

In one embodiment the selectable programmes may be provided as a group of programmes selected from a range of different channels which changes over time so that the selection of the group is made with respect to specific programmes or alternatively specific channels are selected so that while the programmes will change over time they are provided in the same order and on selected channels as they would be provided when streamed as part of a conventional channel service. In one embodiment the group of programmes therefore appears to the user at the user interface as a group of identified channels such as for example, programmes provided on BBC1, Sky News or the like and, most typically, the channels are selected from those channels which are regarded as free to air channels in order to enable the content to be available without the need for provision of a smartcard. However it is possible that the system will include some form of Digital Rights Management (DRM) as an option.

In one embodiment, upon a user selection of a programme, the user's device identifies the relevant portion of data from the received multicast data, and uses the identified portion of data to generate the selected programme or channel on that device.

Typically the user interface is generated on the screen of the users device and will identify the group of programmes or channels available from the service at that time, and the user can then select to view and/or listen to one of the programmes at that time.

In one embodiment the user interface is provided as an “app” or application which can be downloaded to the user's device and thereafter used to make the programme selection. In one embodiment the app includes further user selection options including any or any combination of, selecting to receive other programmes or service via a broadband connection and/or advertising for the service provider.

In one embodiment the system includes a router for use in communication with the server to assist in configuring the data which is to be wirelessly provided at the defined area. The provision of a router which is in association with the system also helps to ensure that the router apparatus which is used is particularly suited and formatted to most efficiently transmit the data wirelessly within the defined area.

In one embodiment the operator or controller of the system is provided with means to block the same data as that required for the said group of programmes from being provided to the defined area via a broadband internet connection. This therefore means that the operator can take steps to prevent duplication of data being provided to the defined area and thereby reduce the amount of data being carried by the broadband internet connection and therefore improve that service.

In one embodiment there is transmission of data from the user's device to the server when the user's device is in the defined area so as to register the device at the server.

Typically therefore the group of programmes or channels is made available to users devices within the defined area whilst ensuring that the content of the programmes is made available in a secure manner.

Typically the data provided for the group of programmes is for standard definition versions of the programmes to minimise the bandwidth required to wirelessly transmit the programme data.

Typically the wireless transmission of the said data to the user devices within the defined area is via a distribution system which is local to that area such as a Local Area Network (LAN).

Most typically the said defined area is a high density populated environment such as a cafe, public transport terminus or any public building.

In one embodiment the server generates a menu of the group of programmes which are available to be selected and this is made available at the user devices within the defined area.

In one embodiment at least some of said data, once received at the server, is placed in memory means at or connected to the server location and selectively transmitted from said server to one or a number of the data processing means receiver locations in response to the receipt of one or more user selections.

In one embodiment the said data which is to be stored in memory is transmitted to the server for storage at a time when usage of the server and/or the number of devices in use within the defined area is identified or predicted to be at a relatively low level.

In one portions of data are sent at intervals to be stored in the memory at the server and the portions of data which are transmitted and stored are for programmes which are predicted to be the most popular user programme selections for a future period of time.

In one embodiment a wireless broadband service to the server is provided at a different frequency to the wireless frequency which is used to transmit the data for the group of available programmes or channels from the server to the user devices within the defined area.

Typically and in accordance with the invention the data which is received at the server and which relates to the said group of programmes is required to be adapted with the remainder of any data which is received by the server unused for the service which is provided to the user devices in accordance with the invention. This ensures that the broadcaster of the data for all channels do not have to change their broadcasts and therefore the selection of the group of programmes or channels and the identification and adaptation of the same can be performed at a local level at or near the said defined area.

The purpose of the adaptation is typically to provide a more “rugged” data stream which can be transmitted and which is therefore more likely to be continuously transmitted successfully over the wireless transmission system and thereby provide a more effective continuous service of the said group of programmes to user devices. This means that although the group of programmes will be typically 10 or less programmes or channels which are available simultaneously and which is therefore less than all of the programmes or channels which would be typically available via, for example, an on demand system, the service in accordance with the invention is much more likely to be able to be provided continually to user devices and is less likely to be affected by, and be caused to fail by, the conventional bottlenecks of lack of broadband capacity and/or wireless transmission problems which can mean that no service at all is provided to the user devices. The applicant has therefore provided a system which allows a reduced but more reliable service to be made available to user devices within a defined area and which service is more robust to an extent that it is not, or is only minimally affected by increase in demand when the defined area is heavily populated with user devices.

In a further aspect of the invention there is provided apparatus for the provision of video and/or audio data at and/or adjacent to a premises, said data received and processed by source apparatus at a first location, and wherein at least one transmitter or transceiver is connected to said source apparatus at a first location and at least one receiver or transceiver is provided at at least one further location in, or adjacent to, the premises, and data is selectively transmitted from the one or more sources via said transmitters to the receivers to allow video and/or audio for selected channels or programmes to be received and used to generate the selected radio and/or television channel or programme via a display screen and/or speakers connected to said receiver or transceiver at said at least one further location

In one embodiment a number of receivers or transceivers are provided at the further location or locations and a plurality of transmitters or transceivers are provided at the first location and control means are provided to allow the provision of data from any one of the transmitters or transceivers to all or selected ones of the receivers or transceivers are the said further location or locations.

In one embodiment the transceiver or receivers at the further location is provided in communication with a means for receiving control signals from a remote control unit which is operable by the user to control the operation of the source apparatus from the further location. Typically, data representative of the detected control signals are transmitted from the receiver or transceiver at the further location to the first location. In one embodiment the control signal data received at the first location is used to generate a mimic of the control signal for use by the apparatus at the first location.

In one embodiment the remote control signals are generated using infra red, and the transceiver at the first location is connected to an infra red emitter which is positioned such as to be within range of the infrared receiver of the apparatus at the first location.

Typically the operation of the source apparatus and distribution of data therefrom is controlled independently by a controller of the system via a data connection to the transmitters or transceivers and switching means in the distribution network.

The data is typically transmitted between the first and further transceivers via wireless communication at at least one predetermined frequency.

In one embodiment the particular data which is transmitted to each of the further locations is controlled such that data for a first programme or channel is transmitted to a first of the further locations, data for the same or a different programme or channel is transmitted to a second of the further locations and so on, and the decision as to the data which is to be transmitted is made by interaction with the system control means.

In one embodiment the interaction is by a controller of the apparatus who is independent from the end user of the apparatus at any of the said further locations. In one embodiment the said user locations are located within the same buildings in different rooms or apartments therein.

In one embodiment, at the time of installation the transmitters or transceivers connected to the data source is switched on and thereafter the receivers or transceivers at the further locations are switched on and tune automatically to the wireless frequency of the first transceiver so as to allow communication between the said apparatus.

In one embodiment the transmitters or transceivers are provided with, or in connection with, a router and the data is transmitted via the router to display and/or speaker apparatus within range of the wireless transmission of the router and which is compatible with or adapted to be able to receive and process the received video and/or audio data and allow the display of the same.

Specific embodiments of the invention are now described with reference to the following Figures; wherein

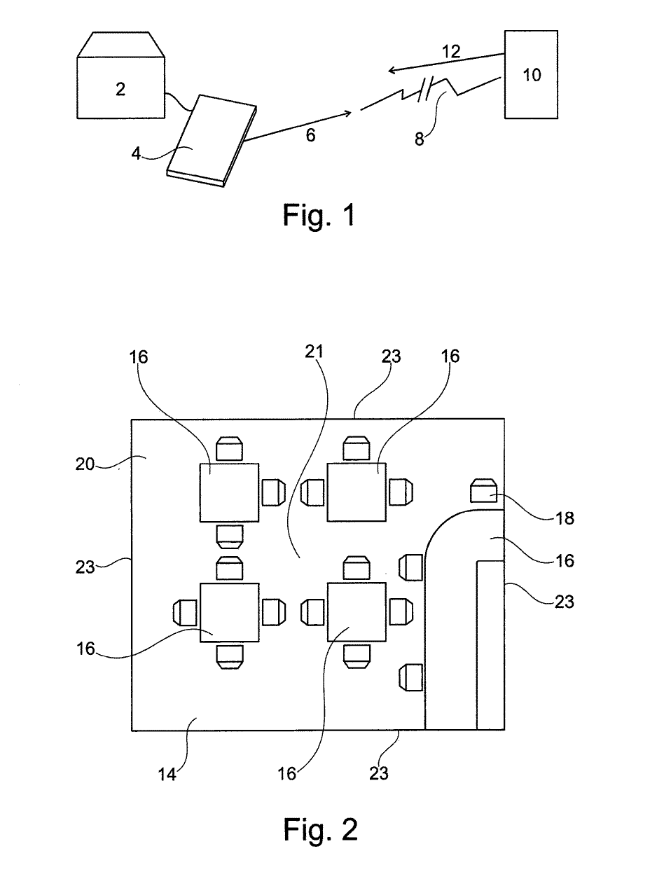

FIG. 1 illustrates schematically a conventional on demand data provision service;

FIG. 2 illustrates schematically a series of user device locations in a defined area in which the invention in a first embodiment is of particular use; and

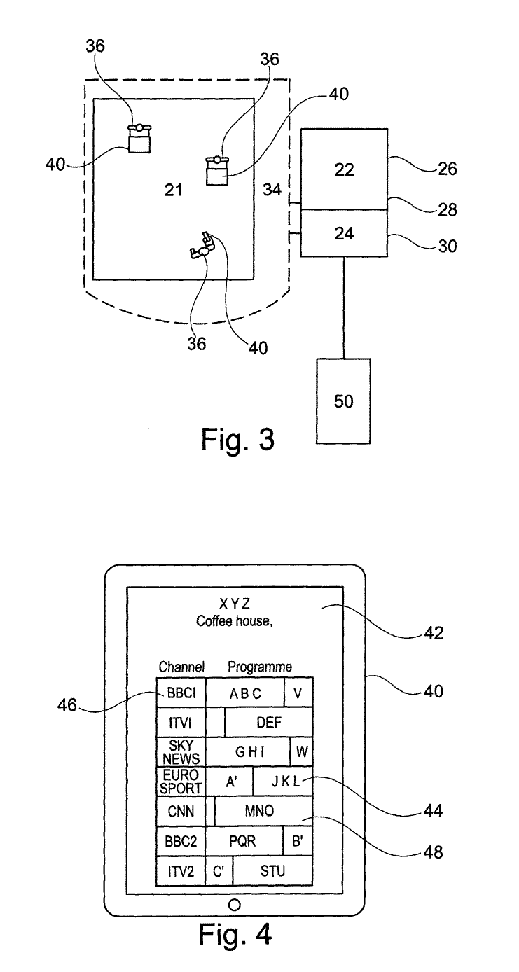

FIG. 3 illustrates an embodiment of the invention in use to provide a programme selection service to the user locations of FIG. 2;

FIG. 4 illustrates a user interface app on a user's device in accordance with eth first embodiment of the invention; and

FIG. 4 illustrates an example of a system in accordance with another embodiment of the invention;

Referring first to FIG. 1, conventionally, an on demand service is provided to a user location 2 in response to a user request. The user request will be generated by the user at the location via an IP type device such as, for example a tablet device 4. The user can access, via a broadband service the on demand service which has the programme which they wish to watch. Having accessed the service, the user selects the programme and a signal representative of the signal is transmitted in the direction 6 from the device 4 and via the broadband service 8 to the remote service provider 10. When the signal is received, the data for the selected programme is transmitted from the service provider via the broadband service in the direction 12 and, typically, the data, when initially received at the device 4, will be buffered until sufficient data is available to allow the programme to be commenced to be shown to the user on their device. The data streaming continues until the data for the whole programme has been sent and received by the user's device. However this type of service is not practical where there is simultaneous demand and bottlenecks are created in the delivery of the required data via the broadband service and/or the wireless transmission of the data at the user location.

FIG. 2 illustrates a public location, in this case a coffee shop 14. The coffee shop has a number of tables 16 and chairs 18. It will be appreciated that if a person sits at each of the chairs and then commences to use a device, there will be a considerable number of devices in use at the same time and each of which can potentially be used to request a programme from an on demand service. Due to the relatively large amount of data which is required to be transmitted via the broadband service to meet each user request, so it will be appreciated that the capacity of the broadband service to the cafe location 20 can quickly become overloaded, as can the wireless transmission system within the defined area and this can cause the failure of the service completely or cause the slowing down of the service such that none of the users will receive a satisfactory service. The coffee shop floor space 21 defined by the walls 23 can therefore be specified as the defined area in which the service is to be provided to users devices.

In accordance with the invention the disadvantages and problems of data supply are overcome. In the invention, as illustrated schematically in FIG. 3 there is provided a server 22 located at, or adjacent to, the defined area 21. The server is provided in connection with a wireless data transmitter router 24 and is provided to receive data from one or more data broadcast services such as terrestrial 26, satellite 28, and/or cable 30 broadcast services. The server is controlled to receive data for onward use by selecting at the server a subset of a group of the programmes or channels which are received and group is to be made available via the service in accordance with the invention. The selection of the group may be made in accordance with criteria set by the owner/operator of the defined area such as, for example, in line with company policy, or may be made and changed on the basis of other criteria such as time of day, with regard to specific events which are occurring. Other criteria may include with respect to the particular geographical location and type of defined area which the server is to provide data to and/or the demographic profile of persons using the defined area.

The server is provided as part of a wireless local distribution network 34, which has a range as shown by the broken lines to cover the particular defined area 21 and is capable of selectively distributing data for the selected group of programmes or channels from the server via router 24 to one or more user devices within the defined area. The devices may be any suitable devices such as laptop, tablet, cell phone or the like which has a wireless capability.

The received data at the server is changed format into an IP protocol format and the data for the group of programmes or channels which is to be made available for selection by the user devices is identified from that which has been received. The identified data is then adapted so as to make the same more “rugged” and resistant to error when wirelessly transmitted to the Local Area Network. This adaptation can typically include the reselection of the lowest possible transmit bit rate, the use of Forward Error correction of the selected data, preferably using raptor coding with the aim at all times to be to reduce the error in the data when received at the user devices. Typically only standard definition data is used for the group of programmes or channels.

Once adapted the data is then transmitted wirelessly, preferably as a multicast of all of the data for the group of programmes or channels and it is from this multicast that the user is able to select a programme via their user device when in the defined area. This means that the service is provided instead of the conventional broadband on demand service. Typically the multicast is a network assisted IP multicast which is implemented to stream the data for the group of programmes or channels simultaneously.

In accordance with the invention therefore, when each of the users 36 in the defined area 21 connects to the local area network via their user device they may have already, or can, download an application for their device 40 which will generate a user interface on the screen of their device. An example of an interface is shown in FIG. 4. The user interface generates a screen display 42 which includes an identity of the service provided which in this case is the operator 42 of the coffee houses in which the defined areas 21 are provided. A grid 44 is displayed which can mimic for example a conventional Electronic Programme Guide (EPG) of an on demand service or television broadcast and which identifies the group of channels 46 and programmes 48 which are available to be selected to be viewed by the user via the service in accordance with the invention. Most typically, but not necessarily, the programmes and channels for the group are selected from those free to air channels which are broadcast to and received by the server in conventional form.

The user can therefore view the available programmes from the group of programmes or channels and select to view one of them at that time by interacting with the user interface in accordance with their specific device format. The application on the user's device then allows the selection of the data for the selected programme from the multicast of all of the data for the group of programmes or channels and generates the selected programme to be viewed and/or listened to on the user's device. This can be repeated by each of the user's via their respective devices to allow the appropriate programme to be selected from the group. It will therefore be appreciated that the group of programmes or channels is a subset of all of the programmes and channels which are broadcast but the provision of the group as a subset provides a manageable amount of data which can be wirelessly broadcast to a defined area for selection by the users in that defined area and which can be achieved so as to provide a robust service.

The user devices may be required to register with the server 22 in which case a handshake request will be transmitted to the server 22 via the local area network 34.

In one embodiment the server may include or be connected to a memory 50 which, most typically when the demand from users is lower, such as overnight receive data which is broadcast or perhaps transmitted by broadband and which is stored in the memory so that the data which is locally stored may be used as one programme or channel in the said group. Alternatively the same may be made available a separate or premium service which is selectable by the user via the user interface and if selected the data is retrieved and made available wirelessly to the users device. This may be used to allow security coded services to be made available.

It will therefore be appreciated that, to the user, the advantages provided by the invention are that they are more likely to receive the data for a selected programme from the group of programmes or channels more reliably and with reduced error quickly so that viewing and/or listening to the programme can commence more quickly. For the service providers there are significant advantages in that the provision of data for at least a group of selectable programmes is possible at the local location, via the wireless communication network more quickly to one or a number of users. This avoids the external broadband or other connection service, which would conventionally have to be used for the transfer of the data independently to each user in a relatively small geographical area, from being required to be used and hence avoids the same becoming overloaded.

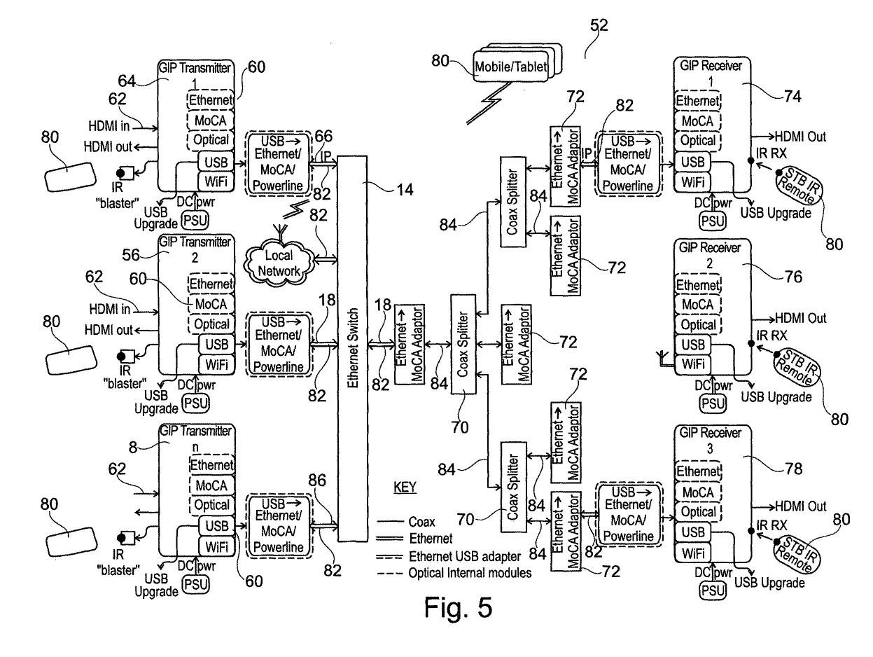

Referring now to FIG. 5 there is illustrated a system 52 which includes a plurality of transmitter devices 54,56,58 at a first location, each of which is provided with the capacity to transmit data over one or a combination of different transmission means and formats. The actual transmission means options which are available can be selected at the time of installation and can also be updated in a modular manner 60. The transmission and connection means may include any, or any combination of Ethernet, MoCA, Optical, USB, powerline and/or Wi-Fi.

In one embodiment each of the transmitters is provided to have an IP based transmission system.

In the system example shown, each of the transmitters is provided with at least one data feed 62 such as that provided from a broadcast data receiver (not shown) such that for example, one data feed may be from a broadcast data receiver which receives data from a satellite broadcast service, another data feed receives data transmitted via a cable broadcast service and so on so that a wide range of channels and programmes can be made available. The physical location of the transmitters does not have to be the same but for practical purposes a bank of the transmitters and associated broadcast data receivers may be provided at the same location and each of the broadcast data receivers may be connected to a satellite, broadband or cable feed.

Each of the transmitters is connected with an output to a common Ethernet switch apparatus 64. In one embodiment the data feeds 66 from each of the transmitters 54,56,58 to be combined and made available to an adapter which allows the data from the Ethernet switch to then be carried, in this case via coaxial cable 68 to one or more signal splitters 70.

Suitable conversion means 72 are provided to allow the conversion of the data into a format suitable for ongoing transmission with the network data format which is to be used at that location.

Each of the splitters 70 provides a data feed to one or more receivers, in this case three receivers 74, 76, 78, in this case via Ethernet, and thereby allows the selected data to be made available for viewing and/or listening via speakers and/or a display screen connected thereto. The number of receiver nodes can be adjusted to suit the specific usage and typically the only limitation will be to avoid data loss affecting the quality of the programme display.

User interaction is possible with each of the receivers and can be performed independently of the other receivers, This therefore allows a user to adjust particular viewing and/or listening preference such as volume and the like.

The selection of the data which is to be fed to each of the receivers is typically controlled by a controller of the system, most typically via common control means such as a tablet, pc or mobile device 53 and thereby allows the overall control of the system to be centralised. This is particularly useful where the system is being provided in a commercial or public use area and in which it is not desired to allow the end viewer or listener to be able to adjust the data and hence channel which is being provided from each of the respective receivers.

Upon receipt of the command signals from the device 80, the identified transmitter 54,56,58 is controlled to identify those of the received data stream or streams which carry the data to allow the requested channel to be provided and that data is streamed from the particular transmitter to the Ethernet switch 64. The control by the device 80 will also identify whether the data for the requested channel is to be provided to each of the receivers, or a combination of the receivers or one of the receivers to thereby control whether, for example, the same channel is to be shown on each of the display screens, a number of the screens connected to the respective receivers 74, 76, 78, or only one of them. In one example, the controller may decide to provide the same channel on each of the screens when there is a particularly popular sporting event occurring such as a football cup final, or decide to show different channels from the respective receivers at other times such as, for example, providing a channel with a football game on a screen connected to receiver 74, a channel with horse racing on the screen connected to receiver 76 and a music channel on the screen connected to the receiver 78 in order to provide a more varied selection of options for viewing by, for example, customers of a public house with different rooms in which the respective television screens and speakers are provided.

Thus, the output of each of the transmitters is set by the system operator and the operator can also determine via the control means 80 which of the data feeds from the transmitters is passed to the respective receivers 74, 76, 78 and where necessary multicast can be used to provide the same data and hence service to each of the receivers. The data can be transmitted using any or any combination of transmission means to suit the environment in which the service is to be provided. For example, with reference to FIG. 5 the system includes an Ethernet connection at portions 82 and a coaxial cable connection at portions 84.

In an alternative embodiment the controller can use the remote control device 80 for that transmitter, at the transmitter location or allow the use of a remote control device 80 at the receivers 74, 76, 78 to allow a signal to be generated for the particular receiver although this may not be practical or popular when there are a large number of viewers at the same location.

1. A system for the transmission of data to a plurality of user devices from one or more sources, said system comprising:
the plurality of user devices located within a defined area being capable of receiving data transmitted wirelessly within said defined area and processing the wirelessly received data to allow video and/or audio to be generated from the wirelessly received data by the plurality of user devices, said plurality of user devices including means to allow user interaction via at least one of the plurality of user device to select, from a group of available programmes or programme channels, a programme to be viewed and/or listened to via the at least one of the plurality of user devices, and
data for a selected programme is obtained from the wirelessly transmitted data so as to be available to the at least one of the plurality of user devices, and
the group of available programmes or channels is selected with reference to predefined criteria by a server which receives data from the one or more sources and is provided in connection with wireless transmission apparatus located so as to transmit data wirelessly to the defined area and thereby make available to the plurality of user devices when located in the defined area the data for the group of available programmes or channels.

2. The system according to claim 1 wherein the group of available programmes or channels is a subset of the programmes or channels for which data is broadcast to the server from one or more consisting of: satellite, cable, DAB, DVBT transmission services.

3. The system according to claim 1 wherein the predefined criteria are determined by a service provider for the defined area and/or an owner or operator of a premises at the defined area.

4. The system according to claim 1 wherein the data for the said group of programmes or channels is adapted following receipt by the server and prior to wireless transmission in order to render the data in a preferred format for wireless transmission.

5. The system according to claim 4 wherein the data received at the server is adapted into an Internet Protocol (IP) format by the server and the selection is made of the data for the group of programmes or channels.

6. The system according to claim 5 wherein the adaptation includes Forward Error Correction (FEC) and/or transcoding of the data and/or to devices when located in the define area.

7. The system according to claim 4 wherein the adaptation includes a reduction of the bit rate at which the data is to be wirelessly transmitted so that the same is sufficiently low so as to ensure reliable transmission of the data to the plurality of user devices within the defined area.

8. The system according to claim 1 wherein the data for the programmes in the group of programmes or channels is multicast wirelessly from the server within the defined area so that the data for all of the group of programmes or channels is available to be received by all of the plurality of user devices located within the defined area.

9. The system according to claim 8 wherein upon a user selection of a programme the user's device identifies a relevant portion of data from the received multicast data, and uses the identified portion of data to generate a selected programme on that device.

10. The system according to claim 1 wherein the means to allow user interaction is a user interface is generated on a screen of the users device and identifies programmes available in the group of available programmes or channels at that time, and a user can then select to view and/or listen to one of a programmes at that time.

11. The system according to claim 10 wherein the user interface is provided as an “app” or application which can be downloaded to the user's device and thereafter used to make the programme selection.

12. The system according to claim 11 wherein the app includes further user selection options including any or any combination of, selecting to receive other programmes or service via a broadband connection and/or advertising for the service provider.

13. The system according to claim 1 wherein the apparatus includes a router for use in communication with the server to configure the data which is to be wirelessly provided at the defined area.

14. The system according to claim 1 wherein an operator of the system is provided with means to block the same data as that required for the group of available programmes or channels which is being provided to the defined area via broadband internet connection so as to reduce an amount of data required to be supplied via the broadband internet connection.

15. The system according to claim 1 wherein there is transmission of data from the user's device to the server when the user's device is in the defined area to register the device at the server.

16. The system according to claim 1 wherein the group of programmes or channels is made available to the plurality of users devices within the defined area whilst ensuring that content of the group of programmes is made available in a secure manner.

17. The system according to claim 1 wherein the data provided for the group of programmes or channels is for standard definition versions of the programmes to minimise bandwidth required to provide the data wirelessly.

18. The system according to claim 1 wherein the wireless transmission of the data to the plurality of user devices within the defined area is via a distribution system which is local to the area such as a Local Area Network (LAN).

19. The system according to claim 1 wherein the defined area is a high density populated environment such as a cafe, public transport terminus or any public building.

20. The system according to claim 1 wherein the server generates a menu of the group of programmes or channels which are available to be selected and the menu is made available at the plurality of user devices within the defined area via a user interface.

21. The system according to claim 1 wherein at least some of said data, once received at the server is placed in memory means at or connected to the server location and selectively transmitted from said server to one or a number of the data processing means receiver locations in response to the receipt of one or more user selections.

22. The system according to claim 21 wherein the said data which is to be stored in memory is transmitted to the server for storage at a time when usage of the server and/or the number of devices in use within the defined area is identified as being at a relatively low level.

23. The system according to claim 21 wherein portions of data are sent at intervals to be stored in the memory means at the server and the portions of data which is transmitted and stored is that for programmes which are predicted to be most popular user programme selections for a future period of time.

24. The system according to claim 1 wherein a wireless broadband service to the server is provided at a different frequency to a wireless frequency which is used to transmit the data for the group of available programmes from the server to the plurality of user devices within the defined area.

25. Apparatus for the provision of video and/or audio data at and/or adjacent to a premises, said apparatus comprising:
data received and processed by a source apparatus at a first location, and wherein at least one transmitter or transceiver is connected to said source apparatus at a first location and at least one receiver or transceiver is provided at at least one further location in, or adjacent to, premises, and data is selectively transmitted from one or more sources via said at least one transmitters to the at least one receivers to allow video and/or audio for selected channels or programmes to be received and used to generate a selected radio and/or television channel or programme via a display screen and/or speakers connected to said at least one receiver or transceiver at said at least one further location

26. Apparatus according to claim 25 wherein a number of receivers or transceivers are provided at the further location or locations and a plurality of transmitters or transceivers are provided at the first location and control means are provided to allow the provision of data from any one of the transmitters or transceivers to all or selected ones of the receivers or transceivers are the said further location or locations.

27. Apparatus according to claim 26 wherein the number of transceivers or receivers at the further location is provided in communication with a means for receiving control signals from a remote control unit which is operable by a user to control operation of the source apparatus from the further location.

28. Apparatus according to claim 27 wherein data representative of detected control signals are transmitted from the number of receiver or transceiver at the further location to the first location.

29. Apparatus according to claim 27 wherein the control signal data received at the first location is used to generate a mimic of the control signal for use by the apparatus at the first location.

30. Apparatus according to claim 27 wherein the remote control it signals are generated using infra red, and the transceiver at the first location is connected to an infra red emitter which is positioned such as to be within range of the infrared receiver of the apparatus at the first location.

31. Apparatus according to claim 25 wherein the operation of the source apparatus and distribution of data therefrom is controlled independently by a controller of the system via a data connection to the transmitters or transceivers and switching means in the distribution network.

32. Apparatus according to claim 25 wherein the data is transmitted between the first and further transceivers via wireless communication at at least one predetermined frequency.

33. Apparatus according to claim 25 wherein particular data which is transmitted to each of the further locations is controlled such that data for a first programme or channel is transmitted to a first of the further locations, data for the same or a different programme or channel is transmitted to a second of the further locations and so on, and the decision as to the data which is to be transmitted is made by interaction with the system control means.

34. Apparatus according to claim 33 wherein the interaction is by a controller of the apparatus who is independent from the end user of the apparatus at any of the said further locations.

35. Apparatus according to claim 25 wherein the said user locations are located within the same buildings in different rooms or apartments therein.

36. Apparatus according to claim 25 wherein at the time of installation the transmitters or transceivers connected to the data source is switched on and thereafter the receivers or transceivers at the further locations are switched on and tune automatically to the wireless frequency of the first transceiver so as to allow communication between the said apparatus.

37. Apparatus according to claim wherein the transmitters or transceivers are provided with, or in connection with, a router and the data is transmitted via the router to display and/or speaker apparatus within range of the wireless transmission of the router and which is compatible with or adapted to be able to receive and process the received video and/or audio data and allow the display of the same.
